(19) United States
(12) Patent Application Publication
(10) Pub. No.: US 2026/0200345 A1
(43) Pub. Date: Jul. 16, 2026

(54) ELECTRIC WATERCRAFT CHARGING SYSTEM AND METHOD OF CHARGING AN ELECTRIC WATERCRAFT

(71) Applicant: BOMBARDIER RECREATIONAL PRODUCTS INC., Valcourt (CA)

(72) Inventors: Adrien LETELLIER, Sherbrooke (CA); Guillaume DOYON, Sherbrooke (CA); Ammar KADER, Sherbrooke (CA)

(21) Appl. No.: 19/134,265

(22) PCT Filed: Oct. 3, 2023
(86) PCT No.: PCT/IB2023/059938

§ 371 Date: May 30, 2025

Related U.S. Application Data
(60) Provisional application No. 63/429,007, filed on Nov. 30, 2022.

(51) Int. Cl. B60L 53/126; B60L 53/30; B63H 21/17; B63H 21/21

(52) U.S. Cl. CPC B60L 53/126; B60L 53/30; B63H 21/17; B63H 21/21; B60L 2200/32; B63H 2021/216

(57) ABSTRACT

An electric watercraft charging system includes an electric watercraft having an electric motor operatively connected to a propulsion system and a battery in electrical communication with the electric motor for powering the electric motor. A wireless power receiving device is supported by a hull of the watercraft and is in electrical communication with the battery. The system also includes a watercraft charging base configured to be engaged by the watercraft in a charging position thereof. The watercraft charging base has a base body configured to engage at least part of the hull and a wireless power transmitting device supported by the base body. The wireless power transmitting device is positioned such that, in the charging position of the watercraft, the wireless power transmitting device wirelessly transmits power to the wireless power receiving device. A method of charging an electric watercraft is also disclosed.

### CROSS-REFERENCE TO RELATED APPLICATION

The present application claims priority to U.S. Provisional Patent Application No. 63/429,007, filed Nov. 30^{th}, 2022 entitled “Electric Watercraft Charging System and Method of Charging an Electric Watercraft”, which is incorporated by reference herein in its entirety.

### FIELD OF TECHNOLOGY

The present technology relates to systems for electrically charging an electric watercraft.

### BACKGROUND

The electrification of vehicles is becoming more commonplace in today's market in an effort to offer consumers vehicular options that minimize emissions. For instance, battery-powered watercraft (i.e., electric watercraft) such as personal watercraft (PWC) are now available to consumers that desire an emissions-free watercraft. However, electric watercraft also face different challenges. For instance, electric watercraft require an electric charging system to charge a battery thereof and may also require dedicated charging equipment available on shore to recharge the batter of the electric watercraft. These solutions may not be ideal as they can be expensive to implement and usually require a particular design to protect electrical connectors associated with the electrical charging system to avoid exposure to the environment in which the electric watercraft operates.

In view of the foregoing, there is a need for an electric watercraft charging system which addresses at least in part some of these defects.

### SUMMARY

It is an object of the present technology to ameliorate at least some of the inconveniences present in the prior art.

According to one aspect of the present technology, there is provided an electric watercraft charging system comprising: an electric watercraft comprising: a hull having a bow and a stern; a deck supported by the hull; a propulsion system supported by the hull and configured to propel the electric watercraft; an electric motor operatively connected to the propulsion system to drive the propulsion system; a battery in electrical communication with the electric motor for powering the electric motor; and a wireless power receiving device supported by the hull, the wireless power receiving device being in electrical communication with the battery; and a watercraft charging base configured to be engaged by the electric watercraft in a charging position of the electric watercraft, the watercraft charging base comprising: a base body configured to engage at least part of the hull in the charging position of the electric watercraft; and a wireless power transmitting device supported by the base body and configured to be in electrical communication with a power source, the wireless power transmitting device being positioned such that, in response to the electric watercraft being in the charging position, the wireless power receiving device is within a charging distance from the wireless power transmitting device such that the wireless power transmitting device wirelessly transmits power to the wireless power receiving device.

In some embodiments, the wireless power receiving device comprises at least one first coil; the wireless power transmitting device comprises at least one second coil; in response to being powered by the power source, the at least one second coil generates a magnetic field; and in use, in the charging position of the electric watercraft, the magnetic field generated by the at least one second coil induces a voltage in the at least one first coil.

In some embodiments, the at least one first coil is disposed at the bow of the electric watercraft.

In some embodiments, the at least one first coil is disposed at the stern of the electric watercraft.

In some embodiments, the at least one first coil is disposed at a longitudinally central portion of the hull between the bow and the stern.

In some embodiments, the at least one first coil includes two first coils; and the two first coils are disposed on opposite sides of a longitudinal centerplane of the electric watercraft.

In some embodiments, the base body is made of molded plastic.

In some embodiments, the base body has a molded shape that is complementary to at least part of the hull of the electric watercraft.

In some embodiments, the base body is configured to support an underside of the hull of the electric watercraft.

In some embodiments, in use, the electric watercraft is drivable onto the base body.

In some embodiments, the watercraft charging base further comprises at least one adjustable member that is adjustably movable to conform to a shape of the at least part of the hull of the electric watercraft.

In some embodiments, the base body is a bunk lift rail configured to at least partially lift the electric watercraft out of the water once the electric watercraft is driven thereon.

In some embodiments, the bunk lift rail is configured to be removably connected to one of a dock and a trailer.

In some embodiments, the electric watercraft is an electric personal watercraft.

According to another aspect of the present technology, there is provided an electric watercraft comprising: a hull having a bow and a stern; a deck supported by the hull; a propulsion system supported by the hull and configured to propel the electric watercraft; an electric motor operatively connected to the propulsion system to drive the propulsion system; a battery in electrical communication with the electric motor for powering thereof; and a wireless power receiving device supported by the hull, the wireless power receiving device being in electrical communication with the battery, the hull of the electric watercraft being configured to engage a watercraft charging base in a charging position of the electric watercraft, the wireless power receiving device being configured to be wirelessly transmitted power from a wireless power transmitting device of the watercraft charging base in response to the electric watercraft being in the charging position.

In some embodiments, at least part of the hull has a shape that is configured to be complementary to a base body of the watercraft charging base.

In some embodiments, the wireless power receiving device comprises at least one coil; the wireless power transmitting device generates a magnetic field; and in use, in the charging position of the electric watercraft, the magnetic field generated by the wireless power transmitting device induces a voltage in the at least one coil of the wireless power receiving device.

In some embodiments, the at least one coil is disposed at the bow of the electric watercraft.

In some embodiments, the at least one coil is disposed at the stern of the electric watercraft.

In some embodiments, the at least one coil is disposed at a longitudinally central portion of the hull between the bow and the stern.

In some embodiments, the at least one coil includes two coils; and the two coils are disposed on opposite sides of a longitudinal centerplane of the electric watercraft.

In some embodiments, the electric watercraft is an electric personal watercraft.

In some embodiments, the wireless power receiving device is disposed inside of the hull.

According to another aspect of the present technology, there is provided a watercraft charging base for electrically charging an electric watercraft, the watercraft charging base comprising: a base body configured to engage at least part of a hull of the electric watercraft in a charging position of the electric watercraft; and a wireless power transmitting device supported by the base body and configured to be in electrical communication with a power source, the wireless power transmitting device being positioned such that, in response to the electric watercraft being in the charging position, the wireless power transmitting device is within a charging distance from a wireless power receiving device of the electric watercraft such that the wireless power transmitting device wirelessly transmits power to the wireless power receiving device.

In some embodiments, the wireless power transmitting device comprises at least one coil; in response to being powered by the power source, the at least one coil generates a magnetic field; and in use, in the charging position of the electric watercraft, the magnetic field generated by the at least one coil induces a voltage in the wireless power receiving device.

In some embodiments, the at least one coil includes two coils; and the two coils are positioned such that, in the charging position of the electric watercraft, the magnetic field generated by each coil is configured to induce a voltage in a respective one of two coils of the wireless power receiving device disposed on opposite sides of a longitudinal centerplane of the electric watercraft.

In some embodiments, the base body is made of molded plastic.

In some embodiments, the base body has a molded shape that is configured to be complementary to the at least part of the hull of the electric watercraft.

In some embodiments, the base body is buoyant.

In some embodiments, the base body is configured to support an underside of the hull of the electric watercraft.

In some embodiments, the watercraft charging base further comprises at least one adjustable member that is adjustably movable to conform to a shape of the at least part of the hull of the electric watercraft.

In some embodiments, the base body is a bunk lift rail configured to at least partially lift the electric watercraft out of the water once the electric watercraft is driven thereon.

In some embodiments, the bunk lift rail is configured to be removably connected to one of a dock and a trailer.

In some embodiments, the wireless power transmitting device is disposed inside of the base body.

According to another aspect of the present technology, there is provided a method of charging an electric watercraft, comprising: driving the electric watercraft onto a watercraft charging base; aligning a wireless power receiving device supported by a hull of the electric watercraft with a wireless power transmitting device supported by a base body of the watercraft charging base; supplying power to the wireless power transmitting device; and in response to supplying power to the wireless power transmitting device, wirelessly transmitting power from the wireless power transmitting device to the wireless power receiving device.

According to another aspect of the present technology, there is provided an electric watercraft charging system comprising: a wireless power receiving device configured to be supported by a hull of an electric watercraft, the wireless power receiving device being configured to be in electrical communication with a battery of the electric watercraft; and a watercraft charging base configured to be engaged by the electric watercraft in a charging position of the electric watercraft, the watercraft charging base comprising: a base body configured to engage at least part of the hull in the charging position of the electric watercraft; and a wireless power transmitting device supported by the base body and configured to be in electrical communication with a power source, the wireless power transmitting device being positioned such that, in response to the electric watercraft being in the charging position, the wireless power receiving device is configured to be within a charging distance from the wireless power transmitting device such that the wireless power transmitting device wirelessly transmits power to the wireless power receiving device.

For purposes of this application, the terms related to spatial orientation such as forwardly, rearward, left and right, are as they would normally be understood by a driver of a vehicle sitting thereon in a normal driving position.

Embodiments of the present technology each have at least one of the above-mentioned objects and/or aspects, but do not necessarily have all of them. It should be understood that some aspects of the present technology that have resulted from attempting to attain the above-mentioned objects may not satisfy these objects and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of an electric personal watercraft in accordance with an embodiment of the present technology;

FIG. 2 is a top plan view of the watercraft of FIG. 1;

FIG. 3 is a bottom plan view of the watercraft of FIG. 1;

FIG. 4 is a left side elevation view of an electric watercraft charging system including the watercraft of FIG. 1 and a watercraft charging base;

FIG. 5 is a perspective view, taken from a top, rear, left side, of the watercraft charging base of FIG. 4;

FIG. 6 is a schematic diagram of a receiver coil assembly of the watercraft of FIG. 1 and a transmitter coil assembly of the watercraft charging base of FIG. 4;

FIG. 7 is a perspective view, taken from a top, rear, left side, of the watercraft charging base according to an alternative embodiment; and

FIG. 8 is a perspective view, taken from a top, rear, left side, of the watercraft charging base of FIG. 7 with the watercraft of FIG. 1 mounted thereon.

### DETAILED DESCRIPTION

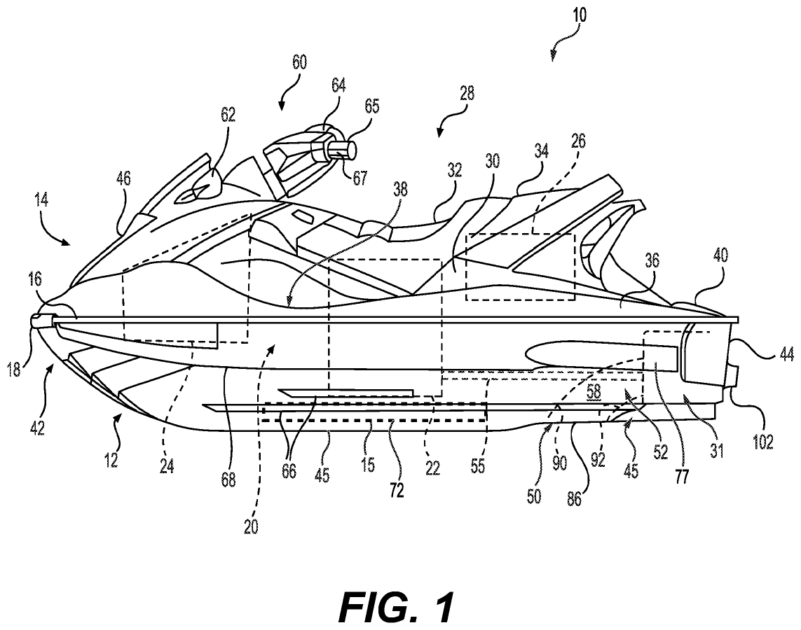

An electric watercraft 10 in accordance with one embodiment of the present technology is shown in FIGS. 1 to 3. In this embodiment, the electric watercraft 10 is an electric personal watercraft (PWC) 10 (i.e., is powered by electricity). Those of ordinary skill in the art will recognize that other types of electric watercraft could also implement the present technology.

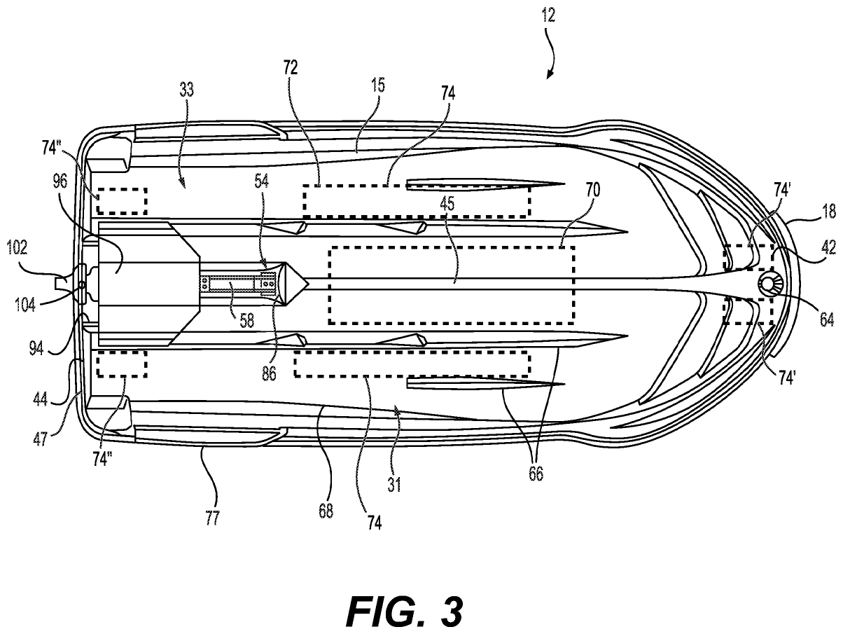

The PWC 10 has a hull 12 and a deck 14 supported by the hull 12. The hull 12 buoyantly supports the PWC 10 in the water. The hull 12 defines a bow 42 and a stern 44 opposite the bow 42, as well as a laterally centered keel 45. The deck 14 is designed to accommodate one or multiple riders. The hull 12 and the deck 14 are joined together at a seam 16 that joins the parts in a sealing relationship. A bumper 18 generally covers the seam 16, which helps to prevent damage to the outer surface of the PWC 10 when the PWC 10 is docked, for example. Sponsons 77 (FIG. 1) are located on both the port and starboard sides of the hull 12 near a transom 47 (FIG. 3). The position of the sponsons 77 with respect to the hull body 15 may be adjustable to change the handling characteristics of the PWC 10 and accommodate different riding conditions. As shown in FIGS. 1 and 3, the hull 12 has a combination of strakes 66 and chines 68 on each of a port side 31 and a starboard side 33 of the hull 12. The port and starboard sides 31, 33 extend on opposite sides of the keel 45. A strake 66 is a protruding portion of the hull 12. A chine 68 is the vertex formed where two surfaces of the hull 12. The combination of strakes 66 and chines 68 provide the PWC 10 with its riding and handling characteristics.

As shown in FIG. 1, the deck 14 has a centrally positioned straddle-type seat 28 positioned on top of a pedestal 30 to accommodate multiple riders in a straddling position. The seat 28 includes a front seat portion 32 and a rear, raised seat portion 34. The seat 28 is preferably made as a cushioned or padded unit, or as interfitting units. The front and rear seat portions 32, 34 are removably attached to the pedestal 30. The seat portions 32, 34 can be individually tilted or removed completely. Seat portion 32 covers a motor access opening defined by a top portion of the pedestal 30 to provide access to an electric motor 22 (shown schematically in FIG. 1) of the electric PWC 10. Seat portion 34 covers a removable storage bin 26 (FIG. 1). A small storage box is provided in front of the seat 28.

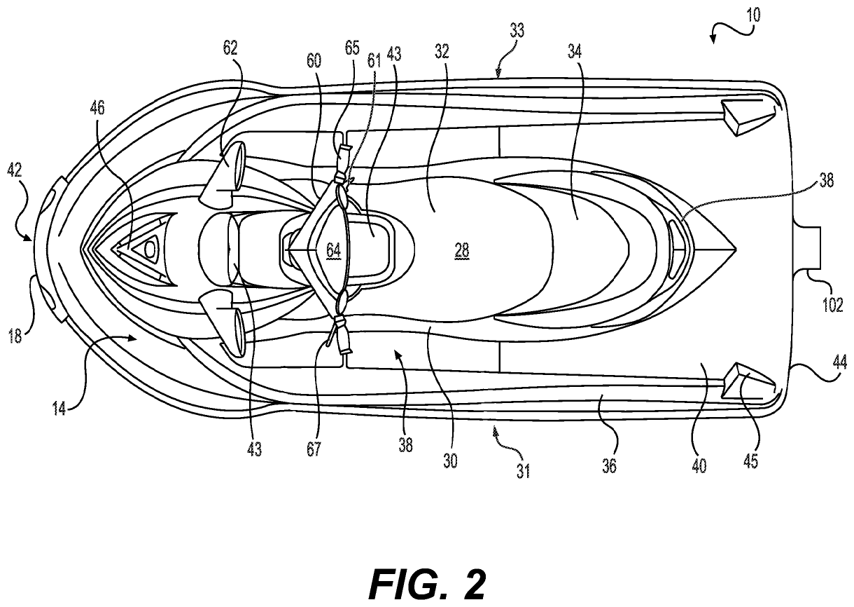

The PWC 10 has a pair of generally upwardly extending walls located on either side of the PWC 10 known as gunwales or gunnels 36. The gunnels 36 help to prevent the entry of water in the footrests 38 of the PWC 10, provide lateral support for the riders'feet, and also provide buoyancy when turning the PWC 10, since the PWC 10 rolls slightly when turning. Towards the rear of the PWC 10, the gunnels 36 extend inwardly to act as heel rests 45 (FIG. 2). A passenger riding the PWC 10 facing towards the rear, to spot a water-skier for example, may place his or her heels on the heel rests 45, thereby providing a more stable riding position. Heel rests 45 could also be formed separately from the gunnels 36.

Located on both sides of the PWC 10, between the pedestal 30 and the gunnels 36, are the footrests 38. The footrests 38 are designed to accommodate the riders'feet in various riding positions. The footrests 38 are covered by carpeting made of a rubber-type material, for example, to provide additional comfort and traction for the feet of the riders.

A reboarding platform 40 is provided at the rear of the PWC 10 on the deck 14 to allow the rider or a passenger to easily reboard the PWC 10 from the water. Nonslip mats or some other suitable covering may cover the reboarding platform 40. A retractable ladder (not shown) may be affixed to a transom 47 (FIG. 3) of the stern 44 to facilitate boarding the PWC 10 from the water onto the reboarding platform 40.

As shown in FIG. 1, the PWC 10 is provided with a hood 46 located forwardly of the seat 28 and a helm assembly 60. A hinge (not shown) is attached between a forward portion of the hood 46 and the deck 14 to allow the hood 46 to move to an open position to provide access to a front storage bin 24. A latch (not shown) located at a rearward portion of the hood 46 locks the hood 46 into a closed position. When in the closed position, the hood 46 prevents water from entering the front storage bin 24. Rearview mirrors 62 are positioned on either side of the hood 46 to allow the rider to see behind the PWC 10. A hook 59 is located at the bow 42 of the PWC 10 (FIG. 2). The hook 59 is used to attach the PWC 10 to a dock when the PWC 10 is not in use or to attach to a winch when loading the PWC 10 on a trailer, for instance.

As best seen in FIG. 2, the helm assembly 60 is positioned forwardly of the seat 28. The helm assembly 60 has a central helm portion 64, that is padded, and a pair of steering handles 65, also referred to as a handlebar. One of the steering handles 65 is provided with an acceleration actuator 61, which allows the rider to control the motor 22, and therefore the speed of the PWC 10. The acceleration actuator 61 is a finger-actuated actuator. However, it is contemplated that the acceleration actuator 61 could be a thumb-actuated lever or a twist grip. The acceleration actuator 61 is movable between an idle position and multiple actuated positions. In this embodiment, the acceleration actuator 61 is biased towards the idle position, such that, should the driver of the PWC 10 let go of the acceleration actuator 61, it will move to the idle position. The other of the steering handles 65 is provided with a reverse gate operator 67 used by the driver to actuate a reverse gate (not shown) of the PWC 10. The reverse gate operator 67 is a finger-actuated lever. However, it is contemplated that the reverse gate operator 67 could be a thumb-actuated lever or a twist grip.

The helm assembly 60 is provided with a key receiving post (not shown) located near a center of the central helm portion 64. The key receiving post is adapted to receive a key that starts the PWC 10. It should be noted that the key receiving post may be placed in any suitable location on the PWC 10.

As shown in FIG. 2, a display area or cluster 43 is located forwardly of the helm assembly 60. The display cluster 43 can be of any conventional display type, including a liquid crystal display (LCD), dials or LED (light emitting diodes). The central helm portion 64 has various buttons, which could alternatively be in the form of levers or switches, that allow the driver to modify the display data or mode (speed, motor rpm, time, etc.) on the display cluster 43 or to change a condition of the PWC 10, such as trim (the pitch of the PWC 10).

As shown schematically in FIG. 1, the electric motor 22 is supported by the hull 12 and is enclosed within a motor compartment 20 defined between the hull 12 and the deck 14. The electric motor 22 is configured for driving a jet propulsion system 50 (also commonly referred to as a “jet pump drive”) which propels the PWC 10. The electric motor 22 is in electrical communication with a battery 70 (schematically illustrated in FIG. 3) which stores electrical energy for powering the electric motor 22. The manner in which the battery 70 is charged will be described in greater detail further below. The motor compartment 20 accommodates the electric motor 22, the battery 70, an electronic control unit, storage bins 24, 26, and other elements required or desirable in the PWC 10.

As mentioned above, the PWC 10 is propelled by the jet propulsion system 50 which pressurizes water to create thrust. To that end, the jet propulsion system 50 has a duct 52 (FIG. 1) in which water is pressurized and which is defined by various components of the jet propulsion system 50, including an intake ramp 58, an impeller housing (not shown), and a steering nozzle 71 of the jet propulsion system 50. A driveshaft 55 is connected between the electric motor 22 and an impeller (not shown) of the jet propulsion system 50. A bellow assembly (not shown) is mounted to the driveshaft 55 and provides a seal between the duct 52 and the hull 12 such as to prevent entry of water into the hull.

As best shown in FIG. 3, the duct 52 has an inlet 86 positioned under the hull 12. When the jet propulsion system 50 is in operation, water is first scooped into the inlet 86. An inlet grate 54 is positioned adjacent (i.e., at or near to) the inlet 86 and is configured to prevent large rocks, weeds, and other debris from entering the jet propulsion system 50, which may damage the system or negatively affect performance. It is contemplated that the inlet grate 54 could be positioned in the inlet 86. Water flows from the inlet 86 through the intake ramp 58. As shown in FIG. 1, the intake ramp 58 has a top portion 90 that is formed by the hull 12 and a bottom portion 92 that is formed by a ride shoe (not shown).

The PWC 10 is also provided with a reverse gate (not shown) which is movable between a stowed position where it does not interfere with the jet of water being expelled rearwardly along the duct 52 by the jet propulsion system 50 and a plurality of positions where it redirects the jet of water being expelled rearwardly along the duct 52 by the jet propulsion system 50. Notably, the reverse gate can be actuated into a neutral position in which the thrust generated by the jet propulsion system 50 does not have a horizontal component such that the PWC 10 will not be accelerated or decelerated by the thrust and will stay in position if it was not moving prior to moving the reverse gate in the neutral position. The reverse gate can also be actuated into a reverse position as it redirects the jet of water towards the front of the PWC 10, thus causing the PWC 10 to move in a reverse direction.

A reverse gate actuator (not shown), in the form of an electric motor, is operatively connected to the reverse gate to move the reverse gate. The reverse gate actuator is actuated in response to an actuation of the reverse gate actuator 67. The reverse gate actuator could alternatively be any one of a mechanical, a hydraulic, or another type of electric actuator.

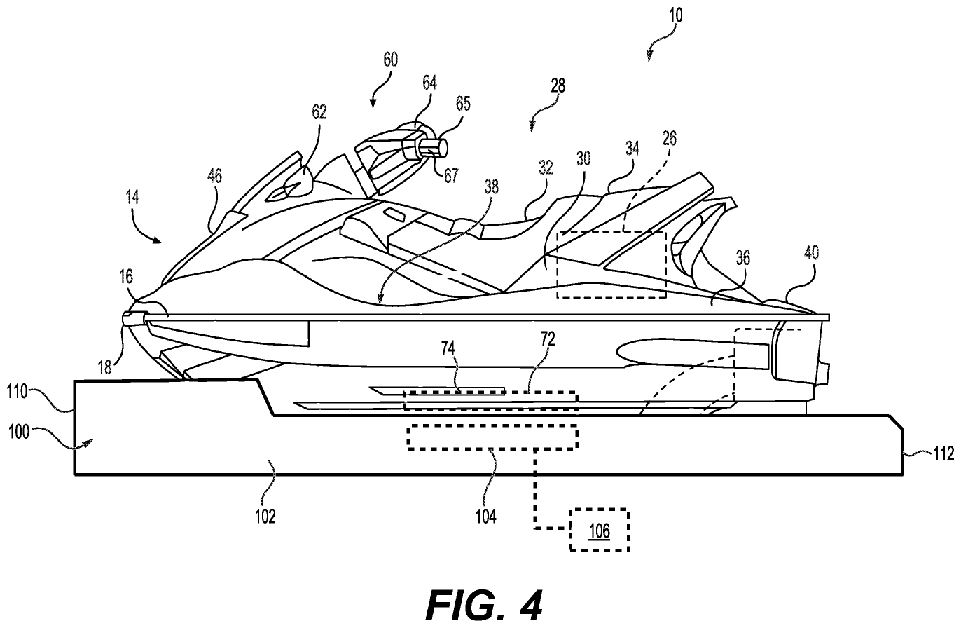

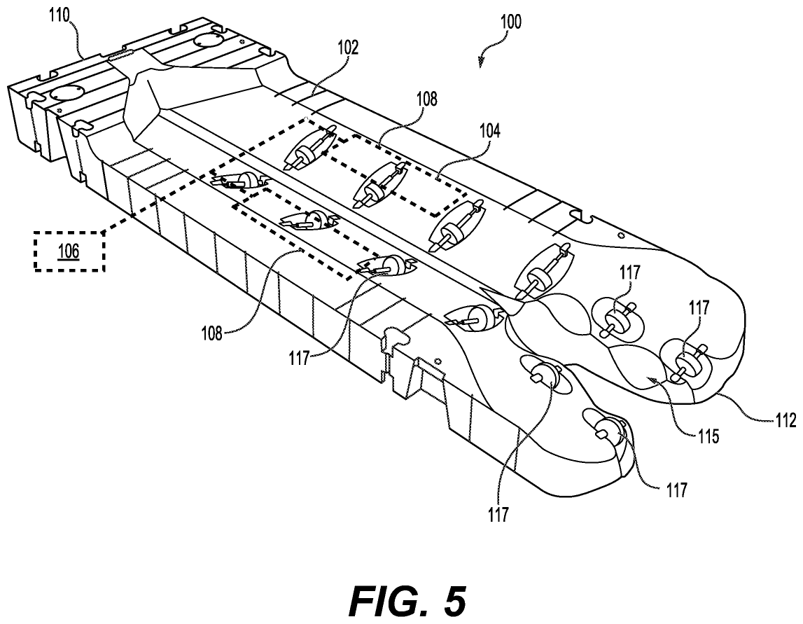

An electric watercraft charging system for charging the battery 70 of the PWC 10 will now be described in greater detail with reference to FIGS. 4 and 5. The electric watercraft charging system includes the PWC 10 and a watercraft charging base 100 that is compatible with the PWC 10. In particular, as illustrated in FIG. 4, the PWC 10 can be placed in a charging position in which the PWC 10 engages the watercraft charging base 100 to cause power transmission from the watercraft charging base 100 to the PWC 10. Notably, as shown in FIGS. 3 and 4, the PWC 10 has a wireless power receiving device 72 that is configured to receive power inductively and is in electrical communication with the battery 70 to transmit electrical power thereto. The wireless power receiving device 72 is supported by the hull 12. In particular, the wireless power receiving device 72 is disposed inside of the hull 12. As such, the wireless power receiving device 72 is hidden from view from an exterior of the PWC 10 and is kept unexposed to the environment surrounding the PWC 10.

As best shown in FIG. 3, in this embodiment, the wireless power receiving device 72 includes a plurality of receiver coil assemblies 74, namely two receiver coil assemblies 74 in this example. It is contemplated that more or fewer receiver coil assemblies 74 could be provided in other embodiments (e.g., a single receiver coil assembly 74). As can be seen, the two receiver coil assemblies 74 are positioned at a longitudinally central portion of the hull 12 between the bow 42 and the stern 44. The receiver coil assemblies 74 could be positioned at different locations along the hull 12 in other embodiments. For instance, in other embodiments, the receiver coil assemblies 74 could alternatively be positioned at the bow 42 or at the stern 44. In FIG. 3, the receiver coil assemblies 74 have been identified as receiver coil assemblies 74′ and 74″ respectively in these alternative positions. Furthermore, as will be appreciated, in this embodiment, the two receiver coil assemblies 74 are disposed on opposite sides of a longitudinal centerplane of the PWC 10 that bisects a width of the PWC 10. More specifically, the positions of the two receiver coil assemblies 74 are generally symmetrical about the longitudinal centerplane of the PWC 10. This may be helpful to ensure a balance of the PWC 10. The positions of the receiver coil assemblies 74 may not be symmetrical about the longitudinal centerplane in other embodiments.

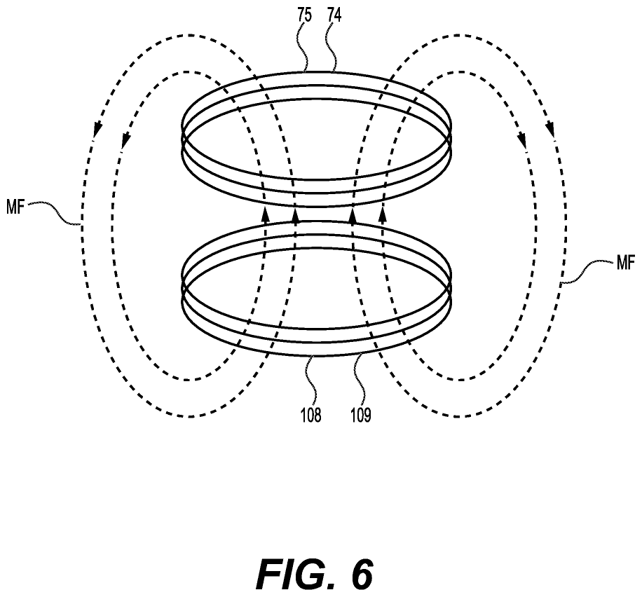

An exemplary one of the receiver coil assemblies 74 is shown in FIG. 6. As can be seen, in this embodiment, each receiver coil assembly 74 includes a receiver coil 75 that includes coiled wire made of an electrically conductive material (e.g., copper). The receiver coil 75 is in electrical communication with the battery 70 such that when a current travels along the receiver coil 75, it is directed to the battery 70 for storage. In some embodiments, the receiver coil assembly 74 could include multiple receiver coils 75, each being in electrical communication with the battery 70. The receiver coil assembly 74 could also include a housing (not shown) in which the receiver coil 75 is at least partially enclosed, and the housing may be connected to the hull 12.

With reference to FIGS. 4 and 5, the watercraft charging base 100 includes a base body 102 and a wireless power transmitting device 104 supported by the base body 102. In this embodiment, the base body 102 is connected to a dock (i.e., a pier used as a landing place or moorage for watercraft) and is disposed floating on the water. Thus, in this embodiment, the base body 102 is buoyant. The base body 102 has a front longitudinal end 110 and a rear longitudinal end 112 defining a length of the base body 102 therebetween. The base body 102 also has a left lateral end 114 and a right lateral end 116 defining a width of the base body 102 therebetween.

In this embodiment, the base body 102 is made from molded plastic and has a molded shape that is complementary to part of the hull 12 of the PWC 10. This can facilitate engagement between the hull 12 and the watercraft charging base 100. In particular, in this embodiment, part of the base body 102 has a shape that is complementary to an underside of the hull 12 such that, in the charging position of the PWC 10, the base body 102 supports the underside of the hull 12. Moreover, the PWC 10 is drivable onto the base body 102. That is, the PWC 10 can be mounted onto the base body 102 while the PWC 10 is in motion on the water, namely, in this example, by engaging a ramp portion 115 (FIG. 5) of the base body 102 disposed at the rear longitudinal end 112. The ramp portion 115 may be omitted in other embodiments as will be described in greater detail below. The complementary shape of the base body 102 to the shape of the hull 12 can allow the PWC 10 to automatically come to a rest in a specific position on the base body 102, without any specific user intervention.

The base body 102 may have a shape complementary to other parts of the hull 12 in other embodiments and thus the base body 102 may not necessarily support the underside of the hull 12 in such embodiments. For example, in some cases, the base body 102 may have a shape complementary to the bow 42 and/or the stern 44 of the hull 12 and may not engage the underside of the hull 12.

The base body 102 may not be buoyant in other embodiments. Moreover, as will be described further below, the base body 102 could be connected to a different structure and/or be disposed atop a support surface in other embodiments.

As shown in FIG. 5, in addition, in this embodiment, the watercraft charging base 100 also includes a plurality of adjustable members 117 connected to base body 102. The adjustable members 117 are adjustably movable to conform to the shape of the underside of the hull 12. When the PWC 10 engages the watercraft charging base 100, the hull 12 engages the adjustable members 117 which therefore at least partially support the hull 12. The adjustable members 117 can be adjustably moved with respect to the base body 102 in order to conform to variations in shape and/or dimensions of the PWC 10. In this embodiment, the adjustable members 117 are rollers that are pivotable about respective axes. As can be seen, the rollers 117 are positioned such that respective subsets of the rollers 117 engage the hull 12 on opposite sides of the longitudinal centerplane of the PWC 10 such that the rollers 117 engage surfaces of the hull 12 on opposite sides of the laterally centered keel 45.

In some embodiments, a winch (not shown) could be provided at the front longitudinal end 110 of the base body 102 in order to pull the PWC 10 onto the base body 102. Notably, the winch could be attached to the hook 59 at the bow 42 of the PWC 10 via a cable and then actuated to reel the PWC 10 toward the front longitudinal end 110 of the base body 102. In such embodiments, the PWC 10 may not be driven onto the base body 102 for example.

In some embodiments, one or more anchors may be provided in order to fix the PWC 10 in place on the base body 102. This may be helpful to further ensure that the PWC 10 does not move significantly when in the charging position on the watercraft charging base 100.

The wireless power transmitting device 104 is, in use, in electrical communication with a power source 106 (schematically illustrated in FIG. 4). For instance, the power source 106 may be a battery or an electrical network (e.g., an alternating current (AC) network). The wireless power transmitting device 104 is configured to inductively transmit power to the wireless power receiving device 72 of the PWC 10. More specifically, the wireless power transmitting device 104 is positioned such that, in response to the PWC 10 being in the charging position, the wireless power receiving device 72 is within a charging distance from the wireless power transmitting device 104 such that the wireless power transmitting device 104 inductively transmits power to the wireless power receiving device 72. The charging distance may vary in different embodiments.

As shown in FIG. 5, in this embodiment, the wireless power transmitting device 104 includes two transmitter coil assemblies 108 that are in electrical communication with the power source 106. The transmitter coil assemblies 108 may be disposed in any suitable place along the base body 102. For instance, in this example, the transmitter coil assemblies 108 are disposed along a central portion of the base body 102, between the front longitudinal end 110 and the rear longitudinal end 112 of the base body 102. Notably, as will be appreciated, the transmitter coil assemblies 108 are positioned such that, when the PWC 10 engages the watercraft charging base 100, the receiver coil assemblies 108 of the PWC 10 are aligned with the transmitter coil assemblies 108 of the watercraft charging base 100. The transmitter coil assemblies 108 may be disposed along other portions of the base body 102 in other embodiments depending on the positions of the receiver coil assemblies 108. For instance, in some cases, if the receiver coil assemblies 74 are disposed at the bow 42, as illustrated at 74′ in FIG. 3, the transmitter coil assemblies 108 could be positioned along a front portion of the base body 102 near the front longitudinal end 110. In other cases, if the receiver coil assemblies 74 are disposed at the stern 44, as illustrated at 74″ in FIG. 3, the transmitter coil assemblies 108 could be positioned along a rear portion of the base body 102 near the rear longitudinal end 112.

An exemplary one of the transmitter coil assemblies 108 is shown in FIG. 6. As can be seen, in this embodiment, each transmitter coil assembly 108 includes a transmitter coil 109 that includes coiled wire made of an electrically conductive material (e.g., copper or aluminium). The transmitter coil 109 is in electrical communication with the power source 106 to receive a current therefrom. A power converter (not shown) of the watercraft charging base 100 electrically connects the power source 106 to the transmitter coil 109. In some embodiments, the transmitter coil assembly 108 could include multiple transmitter coils 109, each being in electrical communication with the power source 106 via the power converter. The transmitter coil assembly 108 could also include a housing (not shown) in which the transmitter coil 109 is at least partially enclosed, and the housing may be connected to the base body 102.

As shown in FIG. 6, the transmitter coil 109 generates a magnetic field MF in response to being powered by the power source 106 (i.e., in response to an electric current being transmitted from the power source 106 through the wire of the transmitter coil 109). In the charging position of the PWC 10, the corresponding receiver coil assembly 74 is within the range of the magnetic field MF generated by the transmitter coil 109 of the transmitter coil assembly 108. Notably, in the charging position of the PWC 10, the magnetic field MF induces a voltage in the corresponding receiver coil 75 thereby inductively transmitting power thereto. A current thus flows from the receiver coil 75 to the battery 70, thereby charging the battery 70. In some embodiments, the current may flow from the receiver coil 75 to electronic components, and then to the battery 70.

The electrical watercraft charging system thus provides a quick and convenient way in which to charge the battery 70 of the PWC 10. Notably, in this embodiment, the PWC 10 can be driven onto the watercraft charging base 10 and placed in a charging position in which the wireless power receiving device 72 is aligned with the wireless power transmitting device 104 of the watercraft charging base 100. Power is then supplied to the wireless power transmitting device 104, thereby causing the inductive transmission of power from the wireless power transmitting device 104 to the wireless power receiving device 72. In particular, because the receiver coil assemblies 74 are aligned with the transmitter coil assemblies 108 and are within a charging distance therefrom as set by the magnetic field MF produced by each of the transmitter coil assemblies 108, a current flow from each of the receiver coil assemblies 74 to the battery 70.

The electrical watercraft charging system thus avoids implementing external electrical connectors which can be susceptible to water ingress and corrosion, particularly in saltwater environments to which the PWC 10 may be exposed. In addition, the omission of external electrical connectors can minimize the risk of damaging the PWC 10 or an external conducting cable during charging, thereby increasing user safety and durability. Furthermore, the system may allow a user to automatically begin charging the PWC 10 as soon as it is docked on the watercraft charging base 100 therefore charging the PWC 10 at any time that it is not in use. As such, the user is not required to remember to plug in a cable, and may not choose to forego plugging the PWC 10 when leaving the PWC 10 docked for a short period of time. In addition, since watercraft docks such as the base body 102 (without the wireless transmitting device 104 described herein and associated electrical components) can typically be found along piers, the use of the watercraft charging base 100 does not add an atypical structure to the pier as would be the case for example for a conventional wired electrical charger.

As will be understood, the electrical watercraft charging system may also allow excluding a typical wired connection on the PWC for charging the battery 70 (i.e., the battery 70 may be charged exclusively via the wireless power receiving device 72. It is contemplated that, in other embodiments, both wired and wireless charging options may be made available for convenience.

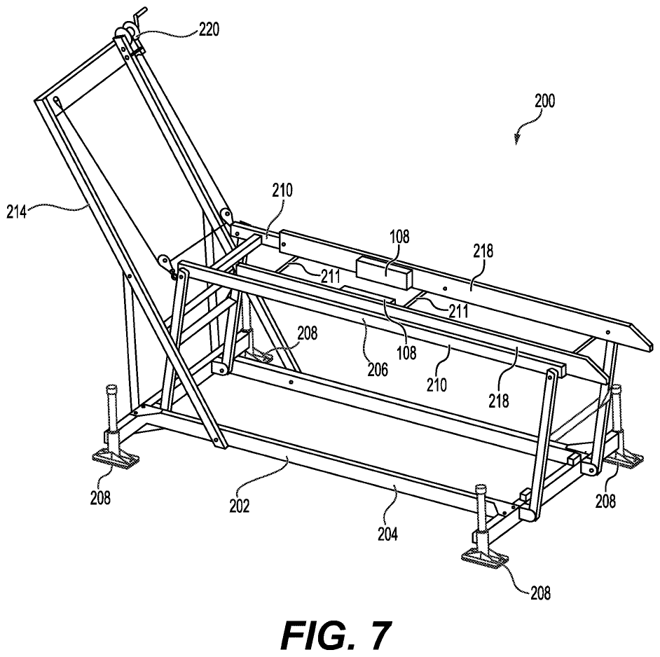

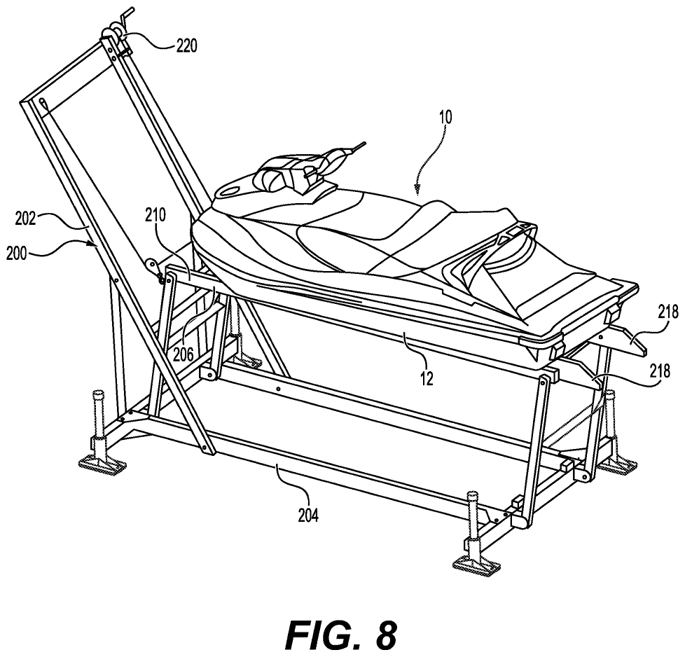

Other types of base bodies of the watercraft charging base are also contemplated. For instance, with reference to FIGS. 7 and 8, in an alternative embodiment, a watercraft charging base 200 having a base body 202 is provided instead of the base body 102 described above. The watercraft charging base 200 also includes the wireless power transmitting device 104 described above. In this alternative embodiment, the base body 202 is a bunk lift rail that is configured to at least partially lift the PWC 10 out of the water once the PWC 10 is driven thereon. That is, the PWC 10 is driven until it is positioned at least partially above the base body 202 and, once in position, the base body 202 can be actuated to lift the PWC 10 out of the water. Such a base body 202 may be removably connected to a supporting structure such as a dock. For instance, in some cases, the base body 202 could be removably connected to a dock or a shore of a body of water. In other cases, the base body 202 may be removably connected to a trailer for transporting the PWC 10 (e.g., a trailer that is connectable to a road vehicle). In this embodiment, the base body 202 has a lower support portion 204 including four anchoring supports 208 which can be connected to an underlying support (e.g., a shore). An upper support portion 206 extends above the lower support portion 204 and is movably connected thereto. The upper support portion 206 includes two longitudinal elongated members 210 connected to each other by transversal members 211. As can be seen, in this embodiment, the two transmitter coil assemblies 108 are connected to respective ones of the longitudinal elongated members 210, along a central portion thereof. Other positions of the transmitter coil assemblies 108 are also contemplated. The base body 202 also includes two slides 218, each slide 218 being connected to a respective longitudinal elongated member 210. The slides 218 are made of a material that facilitates sliding of the hull 12 of the PWC 10 thereon. In this embodiment, a rear end of each slide 218 is slanted to form a ramp portion of the base body 202. This may facilitate driving the PWC 10 onto the base body 202. A front column 214 is connected to the lower support portion 204 and extends upwardly therefrom. A moving assembly 220 is supported by the front column 214 and can be actuated by a user to selectively raise or lower the upper support portion 206 relative to the lower support portion 204. In particular, the moving assembly 220 includes a winch that is operatively connected to the upper support portion 206 by a cable and two pulleys. The winch is actuated to raise or lower the upper support portion 206. More specifically, by actuating the winch, the upper support portion 206 is raised or lowered relative to the lower support portion 204. Other implementations of the bunk lift rail are also contemplated.

Part of the base body 202 of this alternative embodiment may also be removably connected to or integrated as part of a trailer for transporting the PWC 10. For instance, a structure such as the upper support portion 206 may be removably connected to a trailer, or a trailer having a similar structure such as the elongated members 210 may include the transmitter coil assemblies 108. This may allow the battery 70 of the PWC 10 to be charged while being transported.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1.-14. (canceled)

15. An electric watercraft comprising:
a hull having a bow and a stern;
a deck supported by the hull;
a propulsion system supported by the hull and configured to propel the electric watercraft;
an electric motor operatively connected to the propulsion system to drive the propulsion system;
a battery in electrical communication with the electric motor for powering thereof; and
a wireless power receiving device supported by the hull, the wireless power receiving device being in electrical communication with the battery,
the hull of the electric watercraft being configured to engage a watercraft charging base in a charging position of the electric watercraft,
the wireless power receiving device being configured to be wirelessly transmitted power from a wireless power transmitting device of the watercraft charging base in response to the electric watercraft being in the charging position.

16. The electric watercraft of claim 15, wherein at least part of the hull has a shape that is configured to be complementary to a base body of the watercraft charging base.

17. The electric watercraft of claim 15, wherein:
the wireless power receiving device comprises at least one coil;
the wireless power transmitting device generates a magnetic field; and
in use, in the charging position of the electric watercraft, the magnetic field generated by the wireless power transmitting device induces a voltage in the at least one coil of the wireless power receiving device.

18. The electric watercraft of claim 17, wherein the at least one coil is disposed at the bow of the electric watercraft.

19. The electric watercraft of claim 17, wherein the at least one coil is disposed at the stern of the electric watercraft.

20. The electric watercraft of claim 17, wherein the at least one coil is disposed at a longitudinally central portion of the hull between the bow and the stern.

21. The electric watercraft of claim 17, wherein:
the at least one coil includes two coils; and
the two coils are disposed on opposite sides of a longitudinal centerplane of the electric watercraft.

22. The electric watercraft of claim 15, wherein the electric watercraft is an electric personal watercraft.

23. The electric watercraft of claim 15, wherein the wireless power receiving device is disposed inside of the hull.

24. A watercraft charging base for electrically charging an electric watercraft, the watercraft charging base comprising:
a base body configured to:
engage at least part of a hull of the electric watercraft in a charging position of the electric watercraft; and
support an underside of the hull of the electric watercraft;
a wireless power transmitting device supported by the base body and configured to be in electrical communication with a power source,
the wireless power transmitting device being positioned such that, in response to the electric watercraft being in the charging position, the wireless power transmitting device is within a charging distance from a wireless power receiving device of the electric watercraft such that the wireless power transmitting device wirelessly transmits power to the wireless power receiving device.

25. The watercraft charging base of claim 24, wherein:
the wireless power transmitting device comprises at least one coil;
in response to being powered by the power source, the at least one coil generates a magnetic field; and
in use, in the charging position of the electric watercraft, the magnetic field generated by the at least one coil induces a voltage in the wireless power receiving device.

26. The watercraft charging base of claim 25, wherein:
the at least one coil includes two coils; and
the two coils are positioned such that, in the charging position of the electric watercraft, the magnetic field generated by each coil is configured to induce a voltage in a respective one of two coils of the wireless power receiving device disposed on opposite sides of a longitudinal centerplane of the electric watercraft.

27. The watercraft charging base of claim 24, wherein the base body is made of molded plastic.

28. The watercraft charging base of claim 27, wherein the base body has a molded shape that is configured to be complementary to the at least part of the hull of the electric watercraft.

29. The watercraft charging base of claim 24, wherein the base body is buoyant.

30. (canceled)

31. The watercraft charging base of claim 24, wherein the watercraft charging base further comprises at least one adjustable member that is adjustably movable to conform to a shape of the at least part of the hull of the electric watercraft.

32. The watercraft charging base of claim 24, wherein the base body is a bunk lift rail configured to at least partially lift the electric watercraft out of the water once the electric watercraft is driven thereon.

33. The watercraft charging base of claim 32, wherein the bunk lift rail is configured to be removably connected to one of a dock and a trailer.

34. The watercraft charging base of claim 24, wherein the wireless power transmitting device is disposed inside of the base body.

35. A method of charging an electric watercraft, comprising:
driving the electric watercraft onto a watercraft charging base;
aligning a wireless power receiving device supported by a hull of the electric watercraft with a wireless power transmitting device supported by a base body of the watercraft charging base;
supplying power to the wireless power transmitting device; and
in response to supplying power to the wireless power transmitting device, wirelessly transmitting power from the wireless power transmitting device to the wireless power receiving device.

36. (canceled)
